(19) United States
(12) Patent Application Publication
(10) Pub. No.: US 2011/0050691 A1
(43) Pub. Date: Mar. 3, 2011

(54) REAL-TIME USER GUIDED OPTIMIZATION OF GENERAL 3D DATA

(76) Inventors: Koshjar Hamedi, Linkoping (SE); Gustaf Johansson, Linkoping (SE)

(21) Appl. No.: 12/865,551

(22) PCT Filed: Jan. 30, 2009
(86) PCT No.: PCT/SE2009/050094

§ 371 Date: Nov. 17, 2010

(30) Foreign Application Priority Data
Feb. 1, 2008 (SE) 0800241-2

(51) Int. Cl. G06T 17/00; G06T 15/00; G06T 15/50

(52) U.S. Cl. 345/420; 345/419; 345/426

(57) ABSTRACT

The present invention relates to a method semi-automatic simplification of a computer graphics model, where the model is rendered on a display and user controllable pointers on display allows a user to define parts of displayed model interactively and either remove or add data to the computer model in real-time on the chosen areas using automatic simplification algorithms.

### TECHNICAL FIELD

This invention relates generally to 3d modeling and visualization using polygonal meshes for computer graphics, and more particularly to techniques for semi-automatic optimization of polygonal 3d mesh models.

### BACKGROUND ART

3d models in computer graphics are often represented using triangle meshes. Geometrically, a triangle mesh (e.g., example portion of a triangle mesh is a piecewise linear surface consisting of triangular faces joined together along their edges. Many created meshes are typically not optimized for display or simulation performance. In most applications, these initial meshes can usually be replaced by optimized versions that could be approximations with far fewer faces, or containing other properties that make them more suited for particular applications such as simulations, Ray tracing, and real-time visualization.

At present, the computer user (e.g., graphical artist or designers) are often responsible for this hand-tuning of meshes. One approach is to develop mesh simplification tools to automate this task. Previous work has been done on automatic mesh simplification based on edge collapse algorithms, (Mesh simplification and construction of progressive meshes U.S. Pat. No. 5,929,860, and HOPPE, H. 1997. View-dependent refinement of progressive meshes. In Proceedings of ACM SIGGRAPH 97, 189-198.) Previous work has also been done on methods for allowing users to define areas on a mesh in order to enhance the quality of mesh simplification algorithms (Y. Kho and M. Garland. “User-Guided Simplification”, In Proceedings of ACM Symposium on Interactive 3D Graphics, April 2003).

### SUMMARY OF INVENTION

The problem with previous mesh simplification algorithms, including those with user defined areas on the mesh is that they do not allow users to interactively and in real-time remove or add data to 3d models on chosen areas for optimization. This invention describes a method of optimizing models in three dimensions or more using the steps of:

1. Rendering at least parts of the 3d model on a display
2. Choosing a subpart of said displayed model using a user controllable pointer on said display such as a mouse, touch screen, digitizing tablet, graphics pad, drawing table, and keyboard
3. Creating a new model by either adding or removing data from said chosen subpart of model depending on user choice such as right or left clicking on mouse
4. Rendering said new model on said display

The steps of 2 to 3 can then be repeated in order to create an interactive method of optimizing the model. This repeating step can be performed at interactive display rates such as >10 Hz.

The three dimensional models that are optimized can include point clouds, voxels, mesh based models, and any possible combinations thereof. Mesh based models can further comprise a number of vertices and a connectivity of said vertices defining edges between connected pairs of said vertices and faces

The step of displaying the model can comprises a perspective transformation to project the data from the model onto a two dimensional said display, according to a number of camera parameters including camera position, camera orientation, and camera field of view. Once the data is displayed with a perspective transformation the step of choosing a subpart of model on display can be performed by using the steps of:

1. Calculating a ray vector in three dimensions or more originating from the camera position using coordinates of the pointer on display, the camera position, the camera orientation, and the camera field of view
2. Choosing data from the part of the model such as a triangle by choosing the part of the model that is intersected by the ray vector. Once the intersected part is chosen additional surrounding data points to the intersected part can be chosen according to user defined size parameters.

Once a part of the model is chosen the user can further choose parts of the model in the repeating steps by following the surface of the model with the pointer on the screen.

The optimization of the model in the chosen part that comprises adding data to the model can comprises replacing a vertex with a pair of vertices and corresponding edge for said pair of vertices, if the base model is a mesh model Data can also be removed by removing an edge wherein the pair of vertices connected by said edge is replaced by a single vertex in a mesh.

When optimizing a mesh, a method can be used to streamline the disclosed optimization process comprising first creating a Directed Acyclic Graph (DAG) having hierarchical dependencies for edge collapses from the mesh model. The DAG is created in a preprocess before the disclosed optimization process start by using the steps of:

1. Creating a number of root nodes that contain the original mesh where each vertex is represented by one root node, and all edges are defined as connectivities between the root nodes.
2. Performing edge collapses on the root nodes by removing one edge and making that node into a child node belonging to the second root node that was replaced in the edge collapse operation.
The step of 2 can be repeated until the entire root is collapsed and complete DAG is created. The DAG is then further used in the disclosed optimization steps, when adding or removing data by the user on a display.
When removing data subparts of the DAG is chosen according to the chosen subpart of the model. The data is then removed by moving all the last nodes in the chosen subpart of the DAG upwards at least on step in the node hierarchy

The process of adding data is the opposite, where the data is then added by moving all the last nodes in the chosen subpart of the DAG downwards at least on step in the node hierarchy

### BRIEF DESCRIPTION OF THE DRAWINGS

FIG. 1. Shows the relationship between edges, vertices and a triangle

FIG. 2. Displays schematics of the effects of ecol and vsplit transformations performed.

FIG. 3. Displays schematics of a base mesh, and three version of reduced number of triangles/vertices

FIG. 4, Shows transformation information stored in an array, and how it is used in ecol- and vsplit-transformations to change the resolution in the PM

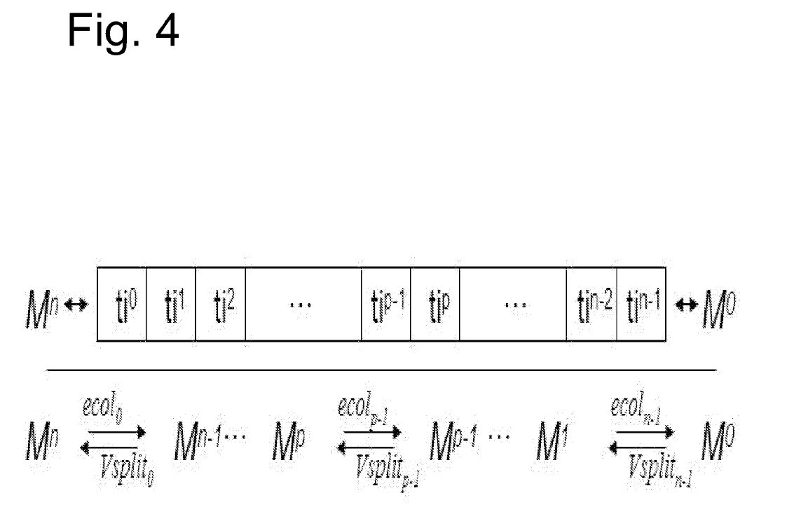

FIG. 5, Displays schematics of building of a dependency-tree

FIG. 6, Displays schematics continuous building a dependency-tree

FIG. 7, Shows that splitting v5 in FIG. 6 would result in two triangles that contain the same 3 vertices. Furthermore, in this case, they would also lie on a straight line, resulting in both of them being degenerate triangles.

FIG. 8, Displays an edge collapse resulting in a triangle folding over two other triangles

FIG. 9, Displays a scenario where all surrounding vertices are intact after collapse

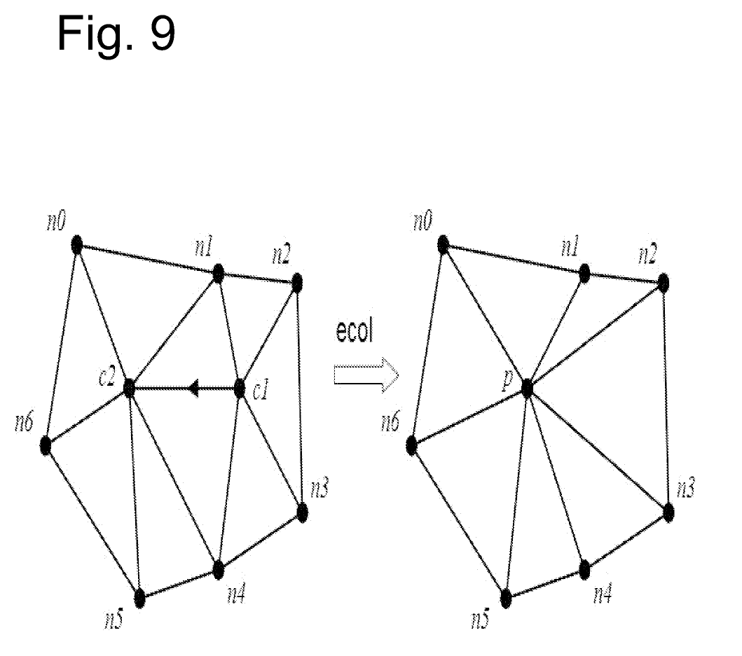

FIG. 10, Shows an edge collapse that only depends on the bordering triangles

FIG. 11, Shows an edge collapse that only depends on t1 and t2

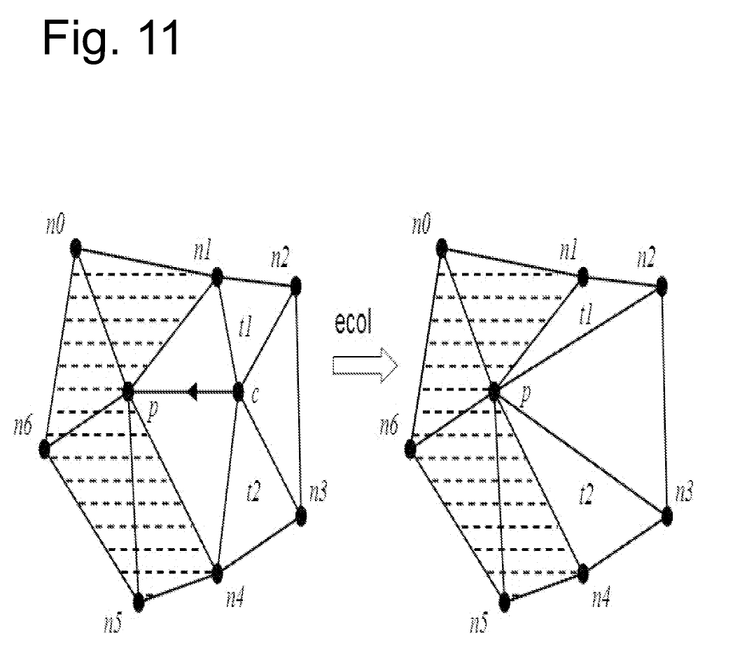

FIG. 12, Displays schematics of a mouse pointer hovering over a mesh

FIG. 13, Displays schematics of a beam with the camera as origin, where the beam intersects the mesh

FIG. 14, Shows x- and y-axis that are calculated from the on display selected triangle

FIG. 15, shows triangles surrounding an originally selected triangle

FIG. 16, Shows a mesh in the process of being selectively reduced in real-time by a user movement of the pointer on display.

FIG. 17, Schematics of how a DAG/dependency tree is traversed in real-time optimization.

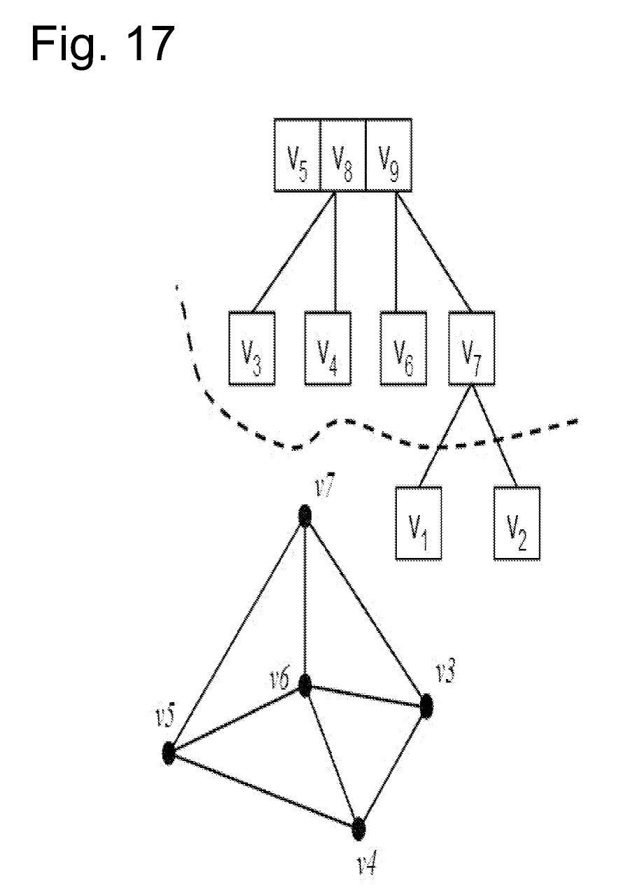

### DETAILED DESCRIPTION

The present invention related to methods of optimizing 3d models by decreasing their complexity/simplification in computer graphics, and can be applied to any type of 3d models including voxels, meshes, NURBS and other types of representations. Other types of objects with more than three dimensions could also be covered by current invention as long as they can be represented on a display after proper transformation to lower dimensions.

The problem with previous optimization/simplification methods is that they do not allow users to interactively and in real-time remove or add data to 3d models on chosen areas for optimization. The disclosed invention describes a method of optimizing 3d models in real-time on a display, so that users such as graphics artists can in real-time in a semi-automatic fashion optimize the model according to their visual needs.

The invention comprises starting with a base model in at least three dimensions and performing the following steps

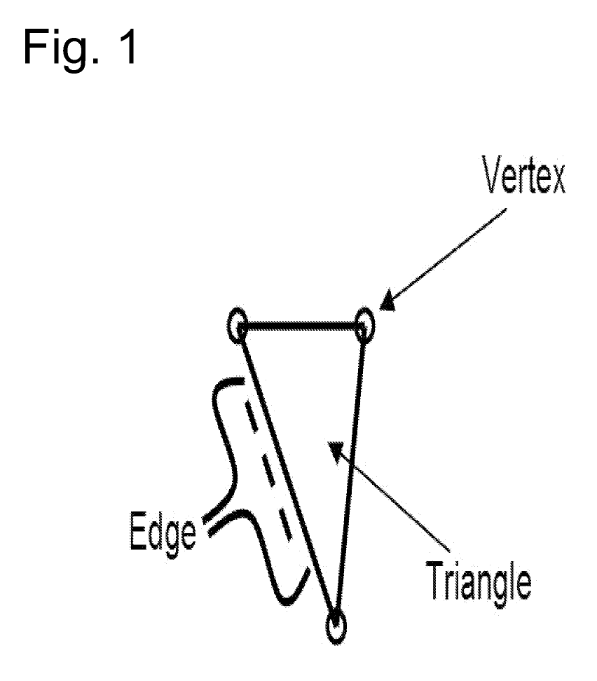

1. Rendering at least parts of the 3d model on a display
2. Choosing a subpart of said displayed model using a user controllable pointer on said display such as a mouse, touch screen, digitizing tablet, graphics pad, drawing table, and keyboard
3. Creating a new model by either adding or removing data from said chosen subpart of model depending on user choice such as right or left clicking on mouse
4. Rendering said new model on said display
if the steps of 2 to 4 are repeated at an interactive speeds the user can in an easy way modify the object to end up with an optimized model with a desired resolution distribution on the 3d model. One way to perform the disclosed invention comprises using a regular computer display and pointer such as a mouse to control the selection and removing or adding of data/resolution to the 3d mode. The mouse buttons or keyboard buttons could for example be used to either add or remove data.
If the 3d data comprises voxels or point clouds, the resolution of the object is intrinsically connected in each voxel or vertex to a certain spatial positions and adding or removing data could comprise just removing or adding the voxels or vertices around the user defined areas.
However the most common way of presenting computer graphics models is by representing them as a mesh built by triangles, which approximate the surface of the model. The more triangles used, the better the approximation. The most basic object used for building a mesh is a vertex. It is a point in 3d-space or more defined by x, y and z . . . coordinates. A straight line that connects two vertices is called an edge. A triangle is defined as three vertices that are all connected with each other through three edges, as seen in FIG. 1 A mesh is a collection of triangles that are attached to each other through the edges of the triangles, that is, they share two vertices.

In order to realize the disclosed invention for 3d mesh objects, it is necessary to use methods that locally can add or remove resolution from a mesh. A method of doing this is described here.

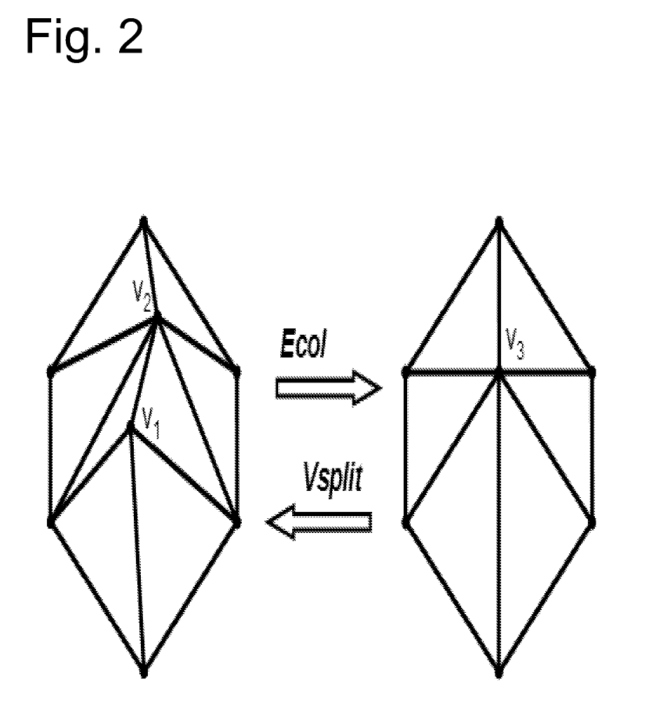

This method relies in reducing the number of triangles, vertices and edges of a mesh using edge-collapse transformation, here also called ecol, The transformation that reverses an edge-collapse is here called a vertex-split, or vsplit FIG. 2

Ecol is performed on an edge that connects two vertices, v1 and v2. These two vertices merge into a new vertex, v3, which results in removal of said edge. All triangles that contained said edge (and thus also vertices v1 and v2) gets removed. All triangles that contained either v1 or v2 (but not both) get re-mapped into containing v3 instead of the previous vertex. See FIG. 2.

Vsplit is performed on a vertex that has at some point been merged from two vertices through an ecol. Vsplit reverses the effect of an ecol, splitting a merged vertex v3 back into two separate vertices, v1 and v2. Vsplit then recreates the edge that connected v1 and v2, recreates removed triangles and re-maps appropriate triangles back to v1 and v2 from v3. See FIG. 2.

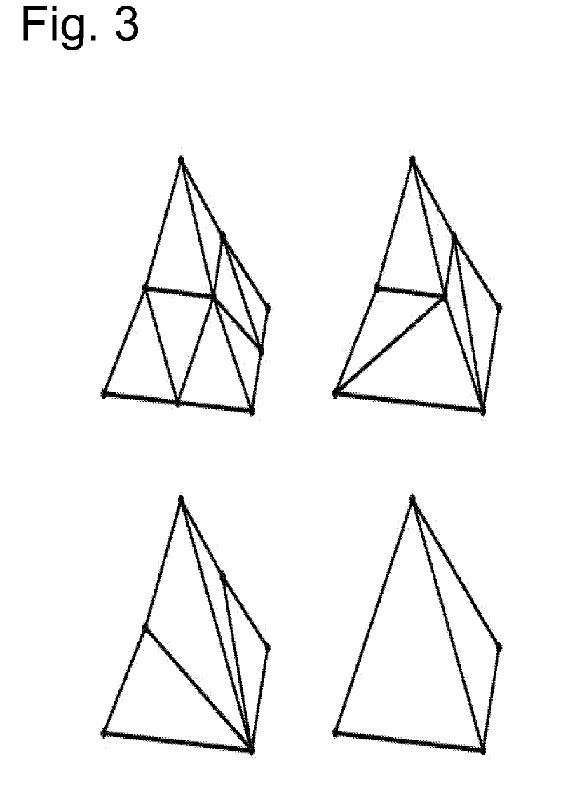

The simplification of a mesh is basically a process that finds an edge that, when ecol is performed on said edge, gives the least volumetric or visual change out of all edges in the mesh. When that edge is found, ecol is performed and the process repeats itself, performing ecol after ecol until some predefined criteria has been met (such as the volumetric change being too big, or number of remaining triangles reach a certain count). FIG. 3 displays a pyramid-like mesh that gradually gets simplified into lower resolution. As can be seen, further ecol-transformations performed on the mesh would result in a mesh that would have lost its pyramid-like shape.

A refineable mesh can best be described as two separate data structures. One which is the original mesh, made up by the vertices and triangles of the mesh, from now on called the mesh data structure, MDS. The other data structure, the refinement data structure, here called RDS, contains information of how the mesh can be restructured through ecols and vsplits

A progressive mesh, here called PM, is a mesh that in real time can change resolution into containing a different amount of triangles and vertices. For a progressive mesh the RDS is produced during the creation of a simplified mesh M^{o} from a basemesh M. M^{o} is created by a sequence of n ecol-transformations performed on the base mesh Mⁿ. This sequence is selected by a mesh-optimization process that aims to preserve as much of features of the original mesh as possible.

During each ecol transformation from M^{p} into M^{p-1}, detailed information regarding the transformation is stored in an element tip that is stored in position p in an array in the RDS. Each element ti^{x} contain information about which two vertices that collapses (these vertices are called children), the new vertex that they merge into (called parents), what triangles that gets removed and what triangles that needs to be remapped into containing the parent where they earlier contained one of the children.

This array can then be traversed, and the information in the array can be used to re-arrange the MDS into a more detailed mesh when performing vsplit transformations while traversing up the array, or creating a less detailed mesh from ecol transformations while traversing down the array.

### Selective Refinement Meshes

Much like the progressive mesh, a selective refinement mesh, SRM, can change resolution in real time. However, the SRM can change the resolution on a selected part of the mesh, leaving the rest of the mesh intact. Instead of having an array with a predefined order of transformations, a tree-structure is created, this tree can also be referred to as a directed cyclic graph (DAG) where each branch has its own predefined order of transformations, independent of the rest of the mesh. They can be considered as small local predefined order of transformations that get narrower and narrower the further down the branch you go. This tree-hierarchy is created in much the same way as the array that is created for a PM. The hierarchy is then used during run-time to perform transformations on the mesh. Performing transformations on the mesh is, however, also depending on a few other factors than just the tree-hierarchy alone. The topology of the surrounding mesh must also be taken into consideration before performing a transformation, or a broken mesh could be created. Two different way of proceeding with the refinement during run-time has been used.

The first method is based on requiring that the topological detail that surround the collapsing edge (or splitting vertex) remains the same as they did during the creation of the tree-hierarchy, to ensure that the transformation is legit. This is the version I have been using, and the requirements for this will be described further down.

The second method doesn't depend on the topological details derived during the tree-hierarchy-creating process, but rather on the topological details of the original mesh. This gives greater flexibility, but also the drawback of having to perform additional checks during runtime to make sure the transformations are legit, and to avoid edge-flips.

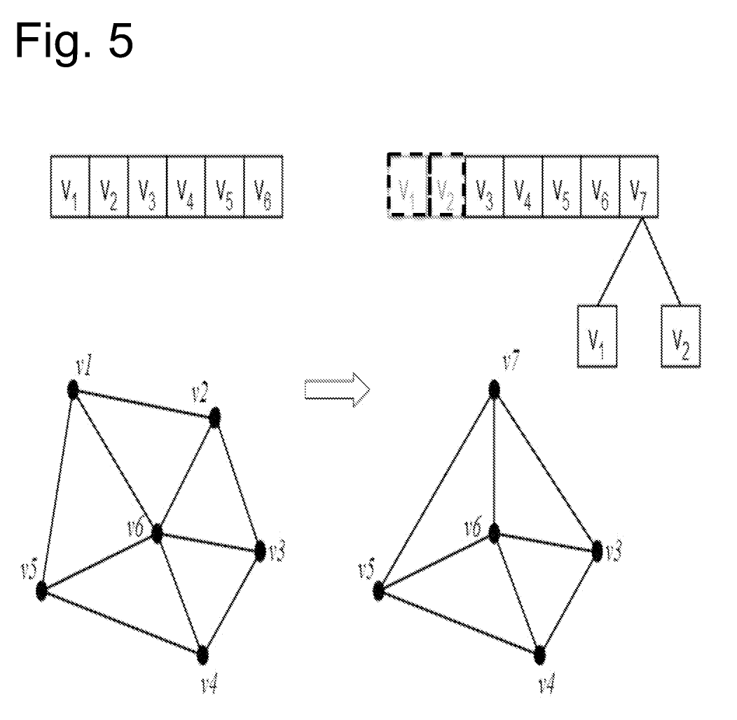

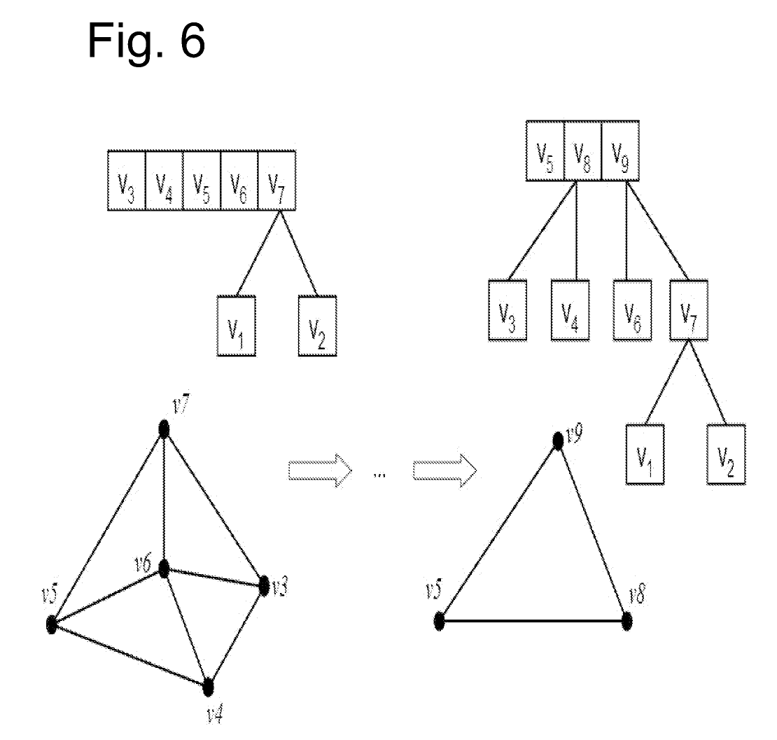

### Creation of the Tree-Hierarchy (DAG)

Where in the creation of the PM information about each transformation was stored in an array, here the information is instead stored as a tree or DAG, with links between parent and child vertices, i.e. links of dependency. First all vertices are stored as the root of this tree-hierarchy. The two collapsing vertices are then selected from the root of the hierarchy, and removed. The resulting parent-vertex is then added to the root. These two collapsing vertices are then added as children to this new parent-vertex. Vertex 1 and 2 are as seen in FIG. 5 removed from the root and placed as children to the new vertex v7. Later on as more vertices from the root are collapsed and moved down the hierarchy, also their children are removed with them, adding more and more levels to the tree. FIG. 6 shows how vertex 3 and 4 are collapsed into vertex 8, and how vertex 6 and 7 are collapsed into vertex 9.

### Dependency for Selective Refinement

Local refinement of the mesh can only be performed by traversing up or down the tree-nodes. A parent-node can not collapse until its children have collapsed first. Root nodes can never collapse, only split (if they have children). A child can not split into its parent unless all the child's children have been already split. Leaf nodes can never split, only collapse (into its parent).

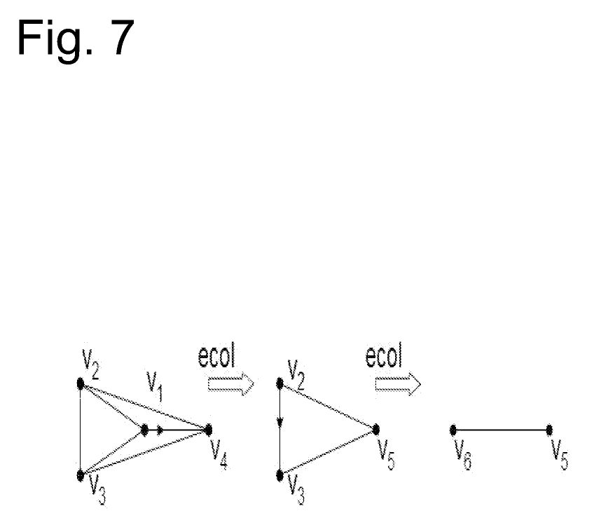

Just using a dependency-tree however is not enough. FIG. 7 displays some examples of situations that can occur if only the hierarchy is being used, and not the surrounding topology.

As can be seen in FIG. 7, the two vertices v1 and v4 both contain v2 and v3 as neighbors. If v5 is trying to split back into v1 and v4 when v2 and v3 has already collapsed into v6, then the two triangles that would be created in the vsplit would both contain v1, v4 and v6, and the mesh could no longer be regarded as a 2-manifold.

Another example is when a collapse would result in a triangle fold-over. In some cases a fold-over is not only ugly, but can also make triangles intersect, and must be avoided. In order to avoid the situations described above, the local topology of the mesh must fulfill certain criteria. These will be described below. In order to check these criteria during runtime, this information too must be stored during the creation o the tree-hierarchy for each transformation.

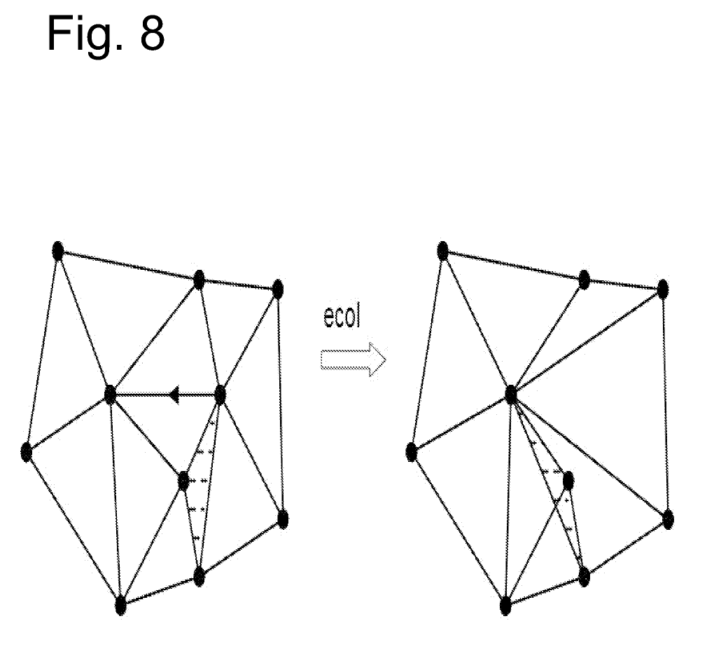

The trivial criteria are shown in FIG. 8, for preserving local mesh topology when performing an ecol or vsplit on a selected sub-group on the mesh. If all vertices (and thus also all triangles) remain the same, then the operation is legit. The obvious drawback of using these criteria is that this greatly restricts the level of freedom for local refinement. This can be summed up as:
All vertices in contact with c1, c2 (and after the collapse, p) need to be active and in direct contact with these for them to be allowed to be collapsed (or split).
None of the vertices in contact with c1, c2 may be involved in a collapse until c1 and c2 has collapsed into p.
None of the vertices in contact with p may be involved in a split until p has split into c1 and c2.

Another version of dependencies is that only the vertices in the triangles t1, t2, t3 and t4 that are important for the local topology. The same rules still apply, but now only to the six triangles contained in the four bordering triangles.

### A Third Version of Dependencies

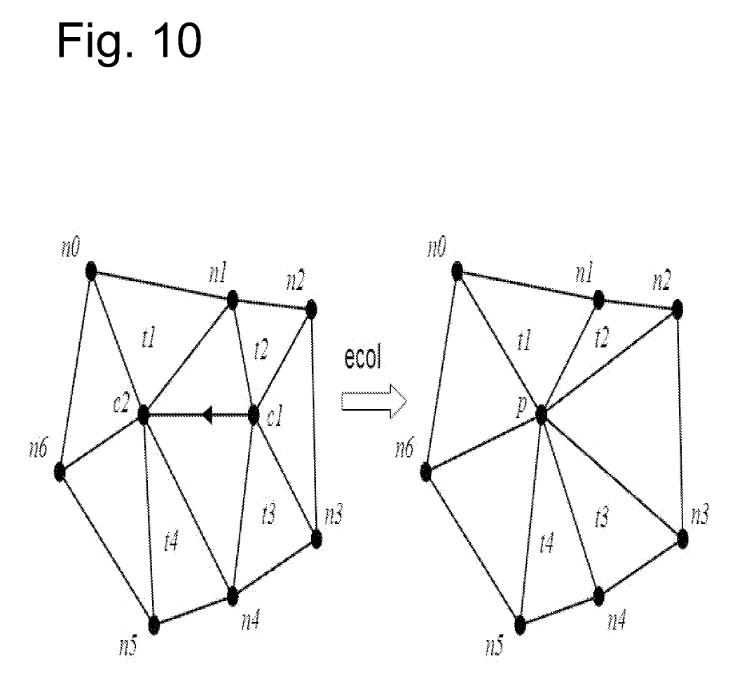

When using half-edge collapses, two vertices doesn't merge into a 3^{rd}, its just one vertex that merges into another vertex, so only half as many triangles needs to be re-mapped during the collapse. As can be seen in FIG. 10, the striped triangles remain the same. This means that the local dependency can be narrowed down to only the vertices contained in the two triangles t1 and t2.

### Traversing the Tree-Hierarchy/DAG

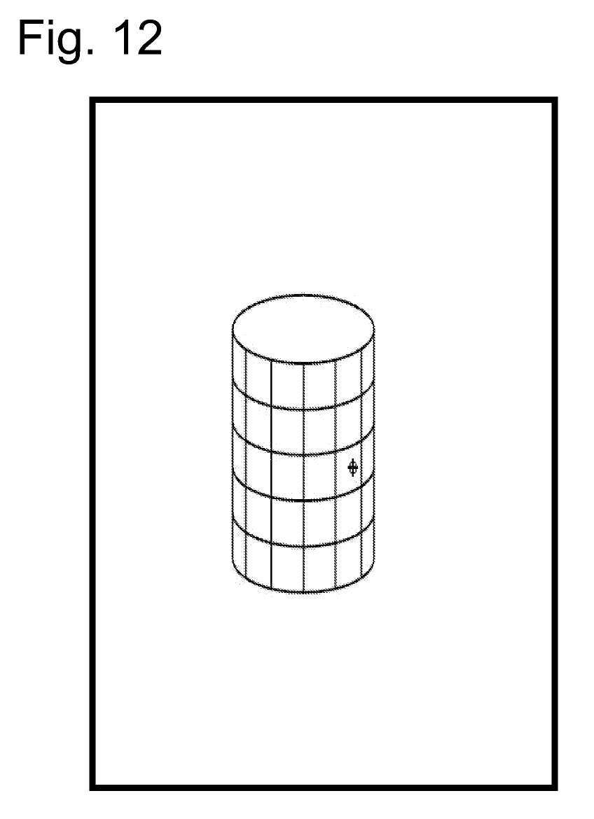

In FIG. 12, the dashed line separates the currently active vertices from the inactive ones, where in the mesh v1 and v2 have been collapsed into v7, but no further collapses have been made. This tree can now be traversed during run-time. The method of traversing can be explained using the following example:

During the creation of the tree-hierarchy, vertex 1 and 2 were first collapsed into vertex 7. After that vertex 3 and 4 were collapsed into vertex 8, and the last collapse was that of vertex 6 and 7 into vertex 9.

If the user chooses vertex 7 in the disclosed invention and chooses to add or remove data, then the local topology criteria say that vertex 8 has to be active in order for the collapse of vertex 6 and 7 to be collapsed. Since vertex 8 will not be active until vertex 3 and 4 have been collapsed, vertex 7 cannot be chosen for collapse. The local topology criteria does however allow vertex 7 to split into vertex 1 and 2.

### Using Selective Refinement to Perform User Guided Real-Time Optimization

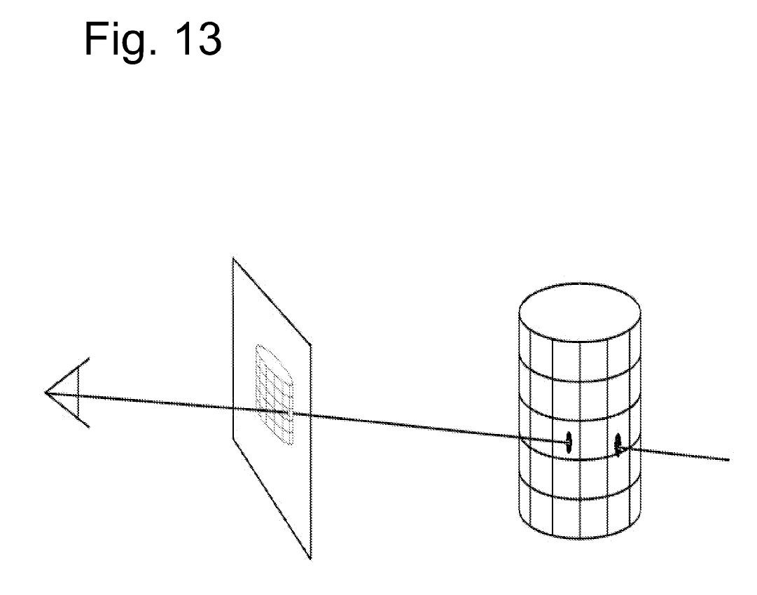

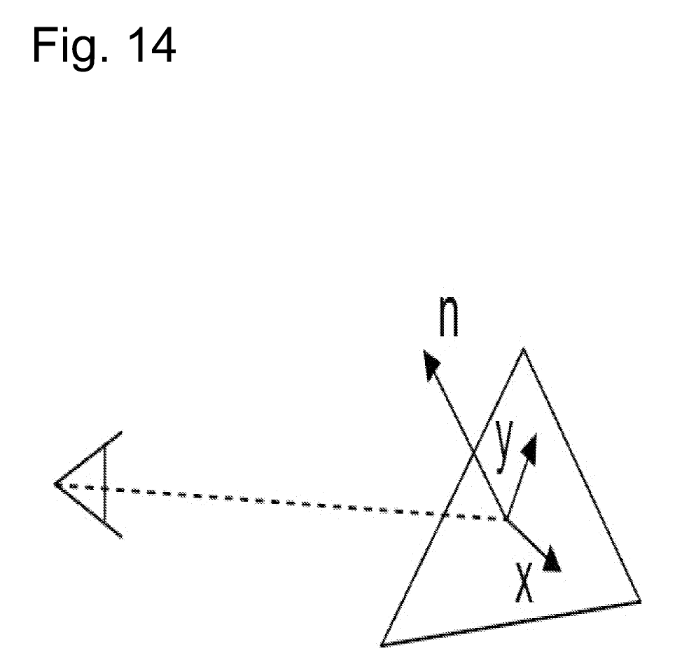

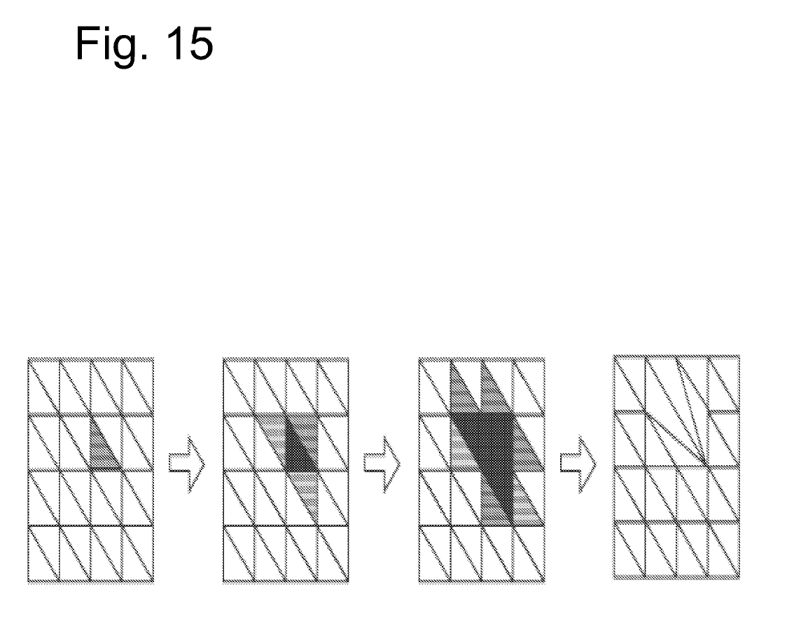

A method to perform the disclosed invention on a 3d triangular mesh after having created the described dependency tree from the base mesh, comprises to use a mouse-pointer to select a triangle on the mesh, as in shown in FIG. 12 and FIG. 13. When the mouse is clicked a beam is sent out from the camera, in the direction of the mouse-pointer in 3d-space. The first triangle that is intersected by this beam is then selected. A marker is then shown on the intersected triangle, on the point of intersection. This marker can then move over the surface of the mesh as the mouse is moved around. Moving the mouse up and down means the marker moves along the y-axis that is calculated on the triangle, according to FIG. 14, and moving the mouse to the left and right moves the marking along the x-axis that is show on FIG. 14.
A number of triangles surrounding the selected triangle are also selected each frame, depending on how big radius the user wants to use. FIG. 15 shows first how the selected triangle is grey. Then the triangles surrounding that triangle are selected, and the original triangle is colored black. These selections of surrounding triangles then go on further and further until sufficient number of triangles are selected. The transformation of choice is then performed on the vertices of the selected triangles, in the fashion and according to the criteria described earlier, with the help of the tree-hierarchy and local topology. In FIG. 15, this operation was an edge collapse.

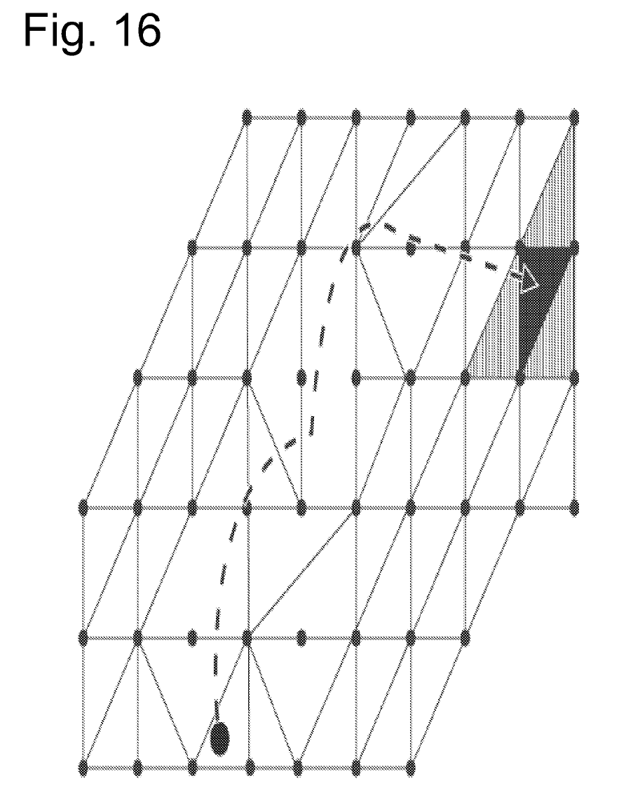

In the following frame the marker moves further along the surface of the mesh, new triangles are selected and more vertices are transformed (either split or collapsed) until the user is done. FIG. 16 shows how the marker starts on the black dot, then frame after frame moves along the mesh (the marker has moved along the dashed line) and the mesh has been collapsed in the trail of this line. In the same way the mesh could have been refined into a more detailed mesh along the dashed line, if the transformation had been split instead of collapse.

### EXAMPLES

### 3D Pens, 3D Displays

One method of realizing the current invention involves using a three dimensional pointer or a haptics device on a 2 or 3 dimensional display so that the user can move around the surface(s) of the displayed model with the pointer and add or remove resolution in real-time. The pointer could be displayed on the display by either representing it as a pointer or as additional local information on the 3d object such as different colors on the mesh triangles at pointer position.

### DCC and CAD Implementation

A method of implementing said invention comprising using the disclosed method of user guided simplification inside or together with a DCC tool such as 3d studio, or soft image, or CAD programs such as AutoCAD.
3D models could then be optimized with the methods of said invention during the process of modification, for example a CAD model of a car could be optimized inside the CAD software in the middle of the creation of the model.

### Scanned Data Implementation Medical, Laser Scanners

The described method could be used for optimization of 3d data that is scanned in order to create data of less complexity, this can include medical data such as MRI data and 3D x-ray, or mesh and point clouds from 3d scanners, such as laser scanners.

### Using Optimized Data for Enhanced Rendering (LOD)

The optimized 3d data according to the current invention could be further used after optimization as stand ins for the original objects to represent another level of detail of the original 3d model, such as in real-time applications for example computer games or simulations, or in off-line renderings such as ray tracing for animation.

1. A method of optimizing a graphics model comprising data in three dimensions or more, comprising the steps of:
rendering at least a part of the model on a display;
receiving input from a user using a user controllable pointer delineating a subpart of the displayed model;
creating a new model by either adding data to or removing data from said chosen subpart of model; and
rendering the new model on the display.

2. (canceled)

3. (canceled)

4. The method of claim 1 wherein the user controllable pointer is controllable by the user using a computer input device.

5. The method of claim 1, wherein the model is further defined as a mesh based model.

6. The method of claim 5, wherein the mesh base model includes a plurality of vertices defining edges between connected pairs of said vertices.

7. The method of claim 1, wherein said step of rendering at least a part of the model is further defined as transforming the graphics model to a two dimensional perspective view on the display, according to a number of camera parameters including camera position, camera orientation, and camera field of view.

8. The method according to claim 7 further comprising the steps of:
calculating a ray vector in three dimensions or more originating from the camera position using coordinates of the pointer on the display, camera position, the camera orientation, and the camera field of view; and
determining at least one intersection data point from the graphics model that is intersected by the ray vector.

9. The method according to claim 8, further comprising the steps of determining at least one neighboring data point surrounding the at least one intersection data point.

10. The method of claim 8 wherein said step of choosing a subpart of the displayed model comprises:
receiving input from a user corresponding to one or more faces of the displayed model; and
choosing subparts of the model based on a path that follows the surface of the model received by the user and originating by ray intersection.

11. The method of claim 6 wherein adding data comprises replacing a vertex of said plurality of vertices with a pair of vertices defining a corresponding edge.

12. The method of claim 1 and claim 6 wherein said removing data comprises removing an edge wherein the defined by a pair of vertices connected by said-the edge is replaced by and replacing the pair of vertices with a single vertex.

13. The method of claim 12 further comprising the steps of:
creating a directed acyclic graph (DAG) having hierarchical dependencies for edge collapses from the mesh based model including the substeps of:
creating a graph root containing the mesh base wherein each vertex is represented by one node in the root, and all edges are defined as connections between root nodes, and
removing one edge from the root by moving one node from the root to become a child node belonging to the second replaced node of the removed edge.

14. The method of claim 13, further comprising the steps of choosing a subpart of the DAG and moving all last nodes in the chosen subpart upwards at least on step in the node hierarchy for removing data.

15. The method of claim 13, further comprising the steps of choosing a subpart of the DAG and moving all last nodes in the chosen subpart downwards at least on step in the node hierarchy for adding data.
